(19) United States
(12) Patent Application Publication
(10) Pub. No.: US 2007/0008246 A1
(43) Pub. Date: Jan. 11, 2007

(54) Plasma display and a method of driving the plasma display

(76) Inventors: Joon-Yeon Kim, Yongin-si (KR); Hak-Cheol Yang, Yongin-si (KR); Sung-Chun Cho, Yongin-si (KR)

Correspondence Address: Robert E. Bushnell, Suite 300, 1522 K Street, N.W., Washington, DC, 20005, US

(21) Appl. No.: 11/437,810

(22) Filed: May 22, 2006

(30) Foreign Application Priority Data
Jul. 8, 2005 (KR) 2005-61601

(51) Int. Cl. G09G 3/28

(52) U.S. Cl. 345/67

(57) ABSTRACT

In a plasma display and a method of driving a plasma display, a discharge is generated in a sustain period since a first voltage is supplied to a scan electrode and a second voltage lower than the first voltage is supplied to a sustain electrode. Accordingly, a discharge current flows since wall charges are formed on the scan and sustain electrodes as a result of the discharge. When the discharge current flows, a third voltage lower than the first voltage and higher than the second voltage is supplied to the sustain electrode while the first voltage is supplied to the scan electrode. In addition, when another discharge current flows since a sustain discharge is generated by supplying the first voltage to the sustain electrode and suypplying the second voltage to the scan electrode, the third voltage is supplied to the scan electrode while the first voltage is supplied to the sustain electrode.

### CLAIM OF PRIORITY

This application makes reference to, incorporates the same herein, and claims all benefits accruing under 35 U.S.C. §119 from an application for PLASMA DISPLAY AND DRIVING METHOD THEREOF earlier filed in the Korean Intellectual Property Office on the 8^{th} of Jul. 2005 and there, duly assigned Serial No. 10-2005-0061601.

### BACKGROUND OF THE INVENTION

1. Field of the Invention

The present invention relates to a plasma display and a method of driving the plasma display.

2. Description of the Related Art

A plasma display is a flat panel display that uses a plasma generated by a gas discharge process to display characters or images. It includes a plurality of discharge cells arranged in a matrix pattern.

One frame of the plasma display is divided into a plurality of subfields, and each subfield includes a reset period, an address period, and a sustain period. The reset period is for initializing the status of each discharge cell so as to facilitate an addressing operation on the discharge cell. The address period is for selecting turned-on/turned-off cells (i.e., cells to be turned on or off). In addition, the sustain period is for causing the cells to either continue a discharge for displaying an image on the addressed cells or to remain inactive.

For the sustain discharge, in the sustain period, a sustain pulse alternately having a high level voltage and a low level voltage is supplied to a scan electrode and a sustain electrode. A sustain pulse phase supplied to the scan electrode is opposite to a sustain pulse phase supplied to the sustain electrode. Since wall charges are formed on a dielectric layer of the scan and sustain electrodes by the sustain discharge, a discharge current flows. Furthermore, wall charges are formed on the scan and sustain electrodes for a predetermined period since the high level voltage is supplied to the scan or sustain electrode for the predetermined period. Accordingly, power consumption is increased since a large amount of discharge current flows for a predetermined period, and the efficiency of the plasma display is reduced.

### SUMMARY OF THE INVENTION

The present invention has been made in an effort to provide a plasma display having a reduced power consumption, and a method of driving the plasma display.

These and other objects of the present invention can be achieved by providing a method of driving a plasma display having a plurality of first electrodes and a plurality of second electrodes, the plurality of first and second electrodes facilitating displaying an image, the method including: supplying a first voltage to one of the plurality of first electrodes and supplying a second voltage lower than the first voltage to one of the plurality of second electrodes; supplying a third voltage lower than the first voltage and higher than the second voltage to the one second electrode while the first voltage is being supplied to the one first electrode, after a first period of time from commencing supplying the first voltage to the one first electrode; supplying the first voltage to the one second electrode and supplying the second voltage to the one first electrode; and supplying the third voltage to the one first electrode after a second period of time from commencing supplying the first voltage to the one second electrode while the first voltage is being supplied to the one second electrode.

A time for supplying the first voltage to the one first electrode preferably includes a time for supplying a third voltage to the one second electrode, and a time for supplying the first voltage to the one second electrode preferably includes a time for supplying the third voltage to the one first electrode.

The second voltage preferably includes a ground voltage.

One period among the first and second periods preferably exceeds a discharge delay time between the one first electrode and the one second electrode.

These and other objects of the present invention can also be achieved by providing a method of driving a plasma display having a plurality of first electrodes and a plurality of second electrodes, the plurality of first and second electrodes facilitating displaying an image, the driving method including: maintaining a voltage at a positive first voltage for a first period, the voltage obtained by subtracting a voltage at one of the plurality of first electrodes from a voltage at one of the plurality of second electrodes; maintaining the voltage for a second period at a positive second voltage lower than the first voltage; maintaining a voltage for a third period at a third voltage higher than the second voltage; and then maintaining the voltage at a positive fourth voltage lower than the third voltage.

The third voltage is preferably equal to the first voltage, and the fourth voltage is preferably equal to the second voltage.

The first and third periods are preferably respectively a discharge delay time between the one first and one second electrodes.

These and other objects of the present invention can further be achieved by providing a plasma display including: a plurality of the first electrodes; a plurality of the second electrodes adapted to facilitate displaying an image in cooperation with the plurality of first electrodes; a first switch coupled between the plurality of first electrodes and a first power source and adapted to supply a first voltage; a first capacitor having a first terminal coupled to the first power source and adapted to supply a second voltage; a second switch coupled between the plurality of first electrodes and a second terminal of the first capacitor; a second capacitor having a first terminal coupled to the second terminal of the first capacitor and adapted to supply a third voltage; a third switch coupled between the plurality of first electrodes and a second terminal of the second capacitor; a fourth switch coupled between the plurality of second electrodes and a second power source and adapted to supply a fourth voltage; a third capacitor having a first terminal coupled to the second power source and adapted to supply a fifth voltage; a fifth switch coupled between the plurality of second electrodes and a second terminal of the third capacitor; a fourth capacitor having a first terminal coupled to the second terminal of the third capacitor and adapted to supply sixth voltage; and a sixth switch coupled between the plurality of second electrodes and a second terminal of the fourth capacitor.

The third and fourth switches are preferably adapted to be turned on for a first period; the fourth switch is preferably adapted to be turned off and the fifth switch is preferably adapted to be turned on, for a second period after the first period; the third and fifth switches are preferably adapted to be turned off, and the first and sixth switches are preferably adapted to be turned on, for a third period after the second period; and the first switch is preferably adapted to be turned off and the second switch is preferably adapted to be turned on, for a fourth period after the third period.

The fifth switch is preferably adapted to be turned off, and the first and fourth switches are preferably adapted to be turned on, for a fifth period between the second period and the third period; and the second switch is preferably adapted to be turned off, and the first and fourth switches are preferably adapted to be turned on, for a sixth period after the fourth period.

The first and second periods are preferably respectively a discharge delay time between the first and second electrodes.

The first voltage is preferably equal to the fourth voltage, and a sum of the second voltage and the third voltage is preferably equal to a sum of the fifth voltage and the sixth voltage. The first and fourth voltages are preferably ground voltages.

The respective second terminals of the second capacitor and the fourth capacitor are preferably coupled to a power source adapted to supply a voltage corresponding to a sum of the first, second, and third voltages.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a block diagram of a plasma display according to an exemplary embodiment of the present invention.

FIG. 2 is the driving waveforms of the plasma display according to the exemplary embodiment of the present invention.

FIG. 3 is a circuit diagram of sustain discharge driving circuits of a scan electrode driver and a sustain electrode driver according to the exemplary embodiment of the present invention.

FIG. 4A and FIG. 4B are respective circuit diagrams of current paths of the driving circuits of FIG. 3.

### DETAILED DESCRIPTION OF THE INVENTION

In the following detailed description, only certain exemplary embodiments of the present invention have been shown and described, simply by way of illustration. As those skilled in the art would realize, the described embodiments can be modified in various different ways, all without departing from the spirit or scope of the present invention.

Accordingly, the drawings and description are to be regarded as illustrative in nature and not restrictive. Like reference numerals designate like elements throughout the specification. When it is described that an element is coupled to another element, the element can either be directly coupled to the other element or coupled to the other element through a third element.

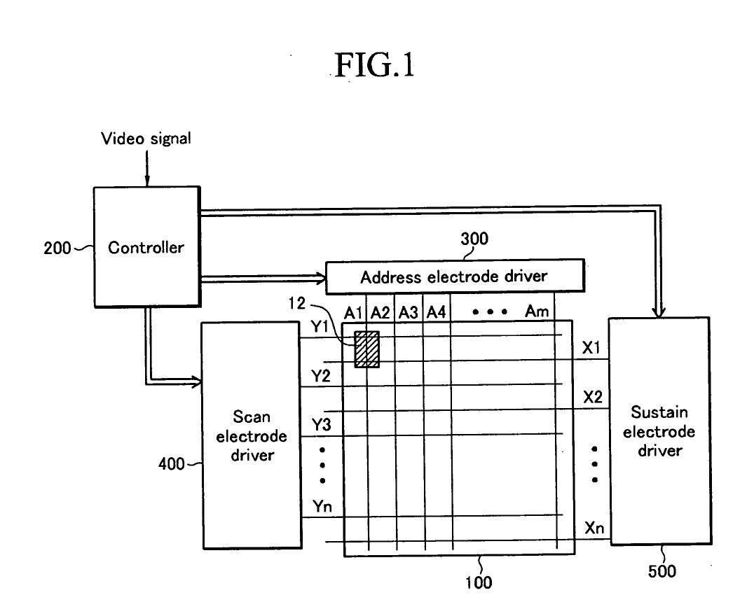

FIG. 1 is a block diagram of a plasma display according to the exemplary embodiment of the present invention.

As shown in FIG. 1, the plasma display according to the exemplary embodiment of the present invention includes a Plasma Display Panel (PDP) 100, a controller 200, an address electrode driver 300, a scan electrode driver 400, and a sustain electrode driver 500.

The PDP 100 includes a plurality of address electrodes A1 to Am (hereinafter referred to as “A electrodes”) extending in a column direction, and a plurality of sustain and scan electrodes X1 to Xn and Y1-Yn (hereinafter respectively referred to as “X electrodes” and “Y electrodes”) extending in a row direction by pairs. The X electrodes X1 to Xn are formed in correspondence with the Y electrodes Y1 to Yn, and a display operation is performed by the X and Y electrodes in the sustain period. The Y and X electrodes Y1 to Yn and X1 to Xn are arranged perpendicular to the A electrodes A1 to Am. A discharge space formed at an area where the address electrodes A1 to Am cross the sustain and scan electrodes X1 to Xn and Y1 to Yn forms a discharge cell 12. The configuration of the PDP 100 of FIG. 1 is an example, and another exemplary configuration can be used in the present invention.

The controller 200 outputs X, Y, and A electrode driving control signals after receiving an external image signal. In addition, the controller 200 operates on each frame divided into a plurality of subfields having respective weight values, and each subfield includes a reset period, an address period, and a sustain period.

After receiving the address driving control signal from the controller 200, the address electrode driver 300 supplies display data signals for selecting discharge cells to be displayed to the respective address electrodes A1-Am.

The X electrode driver 400 supplies a driving voltage to the X electrodes X1-Xn after receiving the X electrode driving control signal from the controller 200, and the Y electrode driver 500 supplies a driving voltage to the Y electrodes Y1-Yn after receiving the Y electrode driving control signal from the controller 200.

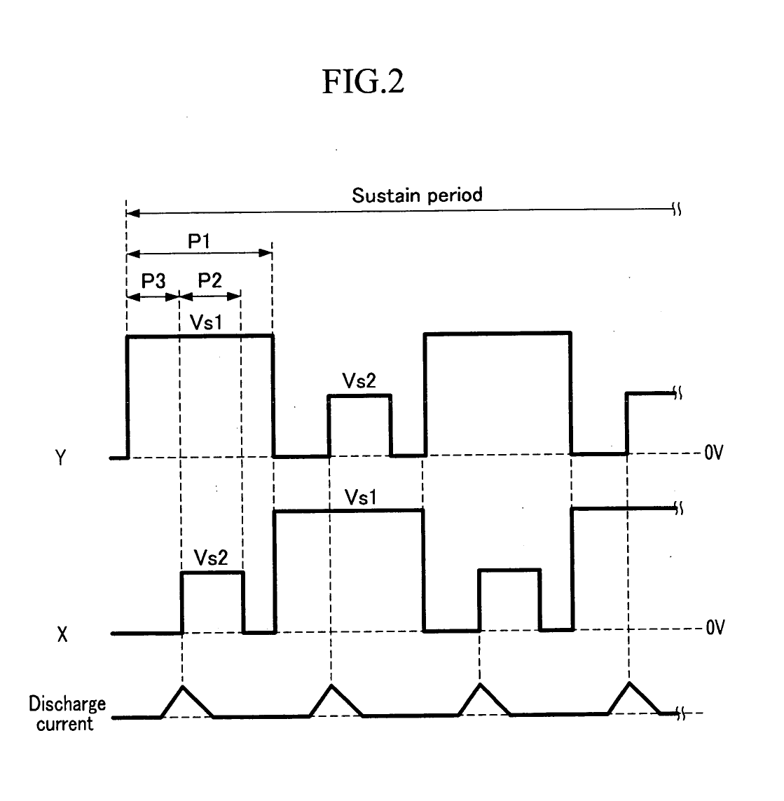

Driving waveforms of the plasma display according to the exemplary embodiment of the present invention are described below with reference to FIG. 2. For convenience, only driving waveforms supplied to the Y, X, and A electrodes forming one cell are described.

In FIG. 2, the driving waveform in the sustain period of one subfield is shown. As shown in FIG. 2, a sustain discharge pulse is supplied to the Y and X electrodes in the sustain period, a sustain discharge pulse phase supplied to the Y electrode is opposite to a sustain discharge pulse phase supplied to the X electrode, and the sustain discharge pulse is repeatedly supplied a number of times corresponding to a brightness weight value of a corresponding subfield. The sustain pulse alternately has a high level pulse of a wide width P1 and a high voltage Vs1, and a low level pulse of a narrow width P2 and a low voltage Vs2. A reference voltage (0V in FIG. 2) is supplied to the X electrode when the high level pulse of the Vs1 voltage is supplied to the Y electrode, and the low level pulse is supplied to the X electrode in a predetermined time P3 after the high level pulse of the Vs1 voltage is supplied to the Y electrode. In a like manner, 0V is supplied to the Y electrode when the high level pulse of the Vs1 voltage is supplied to the X electrode, and the low level pulse is supplied to the Y electrode in the predetermined time P3 after the high level pulse of the Vs1 voltage is supplied to the X electrode.

In general, in a cell selected to be turned on in the address period (not shown), a wall voltage is formed between the Y and X electrodes so that potential of the Y electrode is higher than potential of the X electrode. Therefore, in the sustain period, the high level pulse of the Vs1 voltage is initially supplied to the Y electrode while 0V is supplied to the A and X electrodes. Since the wall voltage is formed between the Y and X electrodes in the cell selected in the address period, the Vs1 voltage is supplied to the Y electrode, and a sustain discharge is generated between the Y and X electrode during a predetermined time period (i.e., a discharge delay time period between the Y and X electrodes). Accordingly, after the sustain discharge is generated, a discharge current flows to the cell since (−) wall charges are formed on the Y electrode and (+) wall charges are formed on the X and A electrodes. When the discharge current flows, the low level pulse of the Vs 2 voltage lower than the Vs1 voltage is supplied to the X electrode. Then, the number of wall charges formed on the X and Y electrodes are reduced, and the discharge current is reduced.

As in the prior art, when the Vs1 voltage is supplied to the Y electrode and 0V is supplied the X electrode, a great number of the wall charges are formed on the Y and X electrodes due to a voltage difference Vs1 supplied to the Y and X electrodes. However, according to the exemplary embodiment of the present invention, when a voltage at the X electrode is increased to the Vs2 voltage after the sustain discharge, a small number of wall charges are formed on the Y and X electrodes since the voltage difference supplied to the Y and X electrodes is reduced to a voltage difference of (Vs1−Vs2). Therefore, the discharge current flowing by forming the wall charge is reduced. Also, luminous efficiency of the plasma display can be increased since the power consumption is reduced. Such a method of increasing the luminous efficiency and reducing the power consumption is disclosed in a publication entitled “Highly Luminous-Efficient AC-PDP with DelTA Cell Structure Using New Sustain Waveforms” (2003 SID) by Y. Seo, Y. Kosaka, H. Inoue, N. Itokawa, and Y. Hashimoto.

Subsequently, the sustain discharge is generated between the Y and X electrodes since 0V is supplied to the Y electrode and the Vs1 voltage is supplied to the X electrode. A small number of wall charges are formed between the Y and X electrodes since the voltage difference supplied to the Y and X electrodes by the previous sustain discharge is the voltage of (Vs1−Vs2). However, the sustain discharge can be generated between the Y and X electrodes since the Vs1 voltage higher than the voltage of (Vs1−Vs2) is supplied to the X electrode. Accordingly, the discharge current flows since (+) wall charges are formed on the Y electrode and (−) wall charges are formed on the X electrode. In addition, when the discharge current flows, the small number of wall charges are formed between the Y and X electrodes since the Vs2 voltage is supplied to the Y electrode. Therefore, the discharge current is reduced. Then, a process for alternately supplying the sustain pulse to the Y and X electrodes is repeatedly performed a number of times corresponding to the weight value of the corresponding subfield.

In addition, while a finishing point of the low level pulse is the same as a finishing point of the high level pulse in FIG. 2, the finishing point of the low level pulse can be earlier or later than the finishing point of the high level pulse. In addition, the low level pulse is supplied in the discharge delay time from a starting point of the high level pulse since it is supplied after the sustain discharge is generated by the high level pulse.

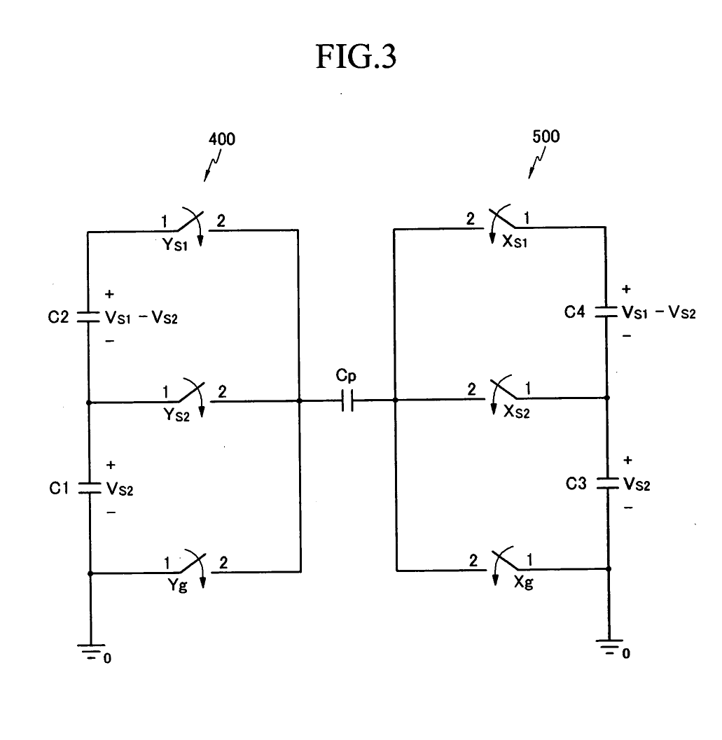

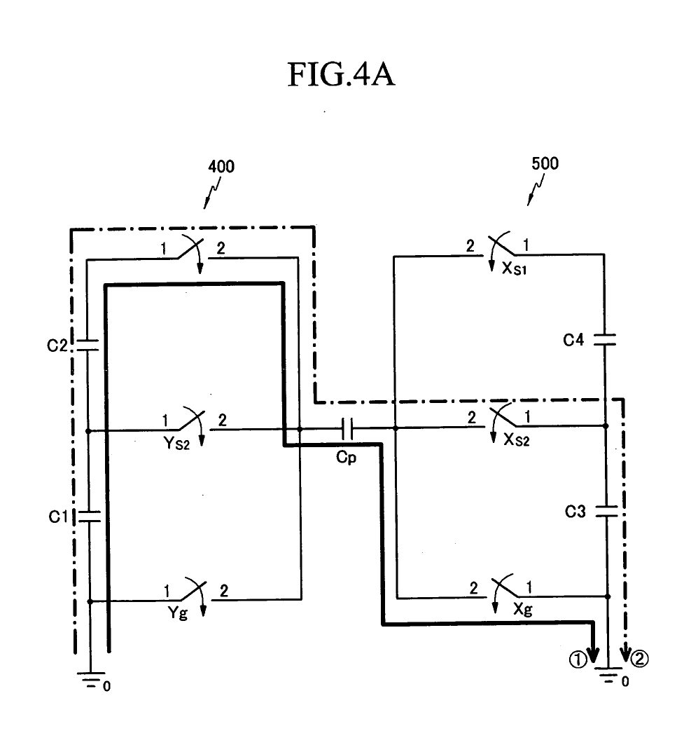

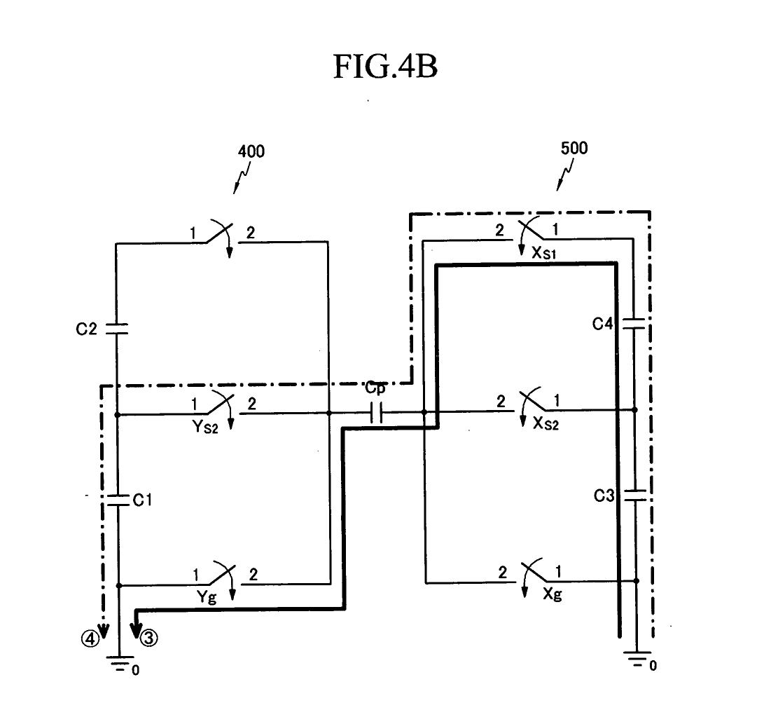

A driving circuit for supplying the driving waveform according to the exemplary embodiment of the present invention is described below with reference to FIG. 3, FIG. 4A, and FIG. 4B. In FIG. 3, FIG. 4A, and FIG. 4B, a capacitance formed by the X and Y electrodes is illustrated as a panel capacitor Cp.

FIG. 3 is a circuit diagram of sustain discharge driving circuits of the scan electrode driver 400 and the sustain electrode driver 500 according to the exemplary embodiment of the present invention.

As shown in FIG. 3, the sustain discharge driving circuit of the scan electrode driver 400 is coupled to a Y electrode of the panel capacitor Cp, and includes switches Ys1, Ys2, and Yg, and capacitors C1 and C2. Respective first terminals of the switches Yg, Ys1, and Ys2 are respectively coupled to a plurality of Y electrodes. A second terminal of the switch Yg is coupled to a ground terminal 0 (i.e., a power source for supplying 0V), and a second terminal of the switch Ys2 is coupled to a second terminal of the capacitor C1 having a first terminal coupled to the ground terminal 0. In addition, a second terminal of the switch Ys1 is coupled to a second terminal of the capacitor C2 having a first terminal coupled to the second terminal of the capacitor C1. The capacitor C1 is charged with the Vs2 voltage, and the capacitor C2 is charged with a voltage of (Vs1−Vs2) corresponding to a difference between the Vs1 voltage and the Vs2 voltage. Therefore, the Vs1 voltage is supplied by the two capacitors C1 and C2. In addition, a power source supplying the Vs1 voltage can be coupled to the first terminal of the capacitor C2 so that the voltage supplied by the two capacitors C1 and C2 can be maintained at the Vs1 voltage.

In a like manner of the sustain discharge driving circuit of the scan electrode driver 400, the sustain discharge driving circuit of the sustain electrode driver 500 is coupled to an X electrode of the panel capacitor Cp, and includes switches Xs1, Xs2, and Xg, and capacitors C3 and C4. Respective first terminals of the switches Xg, Xs1, and Xs2 are respectively coupled to a plurality of X electrodes. A second terminal of the switch Xg is coupled to a ground terminal 0 (i.e., a power source supplying 0V), and a second terminal of the switch Xs2 is coupled to a second terminal of the capacitor C3 having a first terminal coupled to the ground terminal 0. In addition, a second terminal of the switch Xs1 is coupled to a second terminal of the capacitor C4 having a first terminal coupled to the second terminal of the capacitor C3. The capacitor C3 is charged with the Vs2 voltage, and the capacitor C4 is charged with a voltage of (Vs1−Vs2) corresponding to a difference between the Vs1 voltage and the Vs2 voltage. Therefore, the Vs1 voltage is supplied by the two capacitors C3 and C4. In addition, the power source supplying the Vs1 voltage can be coupled to the first terminal of the capacitor C2 so that the voltage supplied by the two capacitors C1 and C2 can be maintained at the Vs1 voltage.

FIG. 4A and FIG. 4B are respective circuit diagrams of current paths of the driving circuits of FIG. 3.

The switches Ys1 and Xg are turned on in a mode 1. Then, as shown in FIG. 4A, a current path □ is formed through the capacitors C1 and C2, the switch Ys1, the panel capacitor Cp, the switch Xg, and the ground terminal 0. Through the current path □, the Vs1 voltage having been charged in the capacitors C1 and C2 is supplied to the Y electrode of the panel capacitor Cp, and 0V is supplied to the X electrode of the panel capacitor Cp.

In the predetermined time P3 after the Vs1 voltage is supplied to the Y electrode, the switch Xs2 is turned on and the switch Xg is turned off in a mode 2. Then, as shown in FIG. 4A, a current path □ is formed through the capacitors C1 and C2, the switch Ys1, the panel capacitor Cp, the switch Xs2, the capacitor C3, and the ground terminal 0. The Vs voltage is supplied to the X electrode of the panel capacitor Cp through the current path □. In addition, when a discharge is generated between the Y and X electrodes by the Vs1 voltage and 0V supplied in the mode 1, a discharge current flows through the current path 0 to charge the capacitor C3.

In the mode 3, the switches Xs1 and Yg are turned on, and the switches Xs2 and Ys1 are in a turn-off state. Then, as shown in FIG. 4B, a current path □ is formed through the capacitors C3 and C4, the switch Xs1, the panel capacitor Cp, the switch Yg, and the ground terminal 0. Through the current path □, the Vs1 voltage having been charged in the capacitors C3 and C4 is supplied to the X electrode of the panel capacitor Cp, and 0V is supplied to the Y electrode of the panel capacitor Cp.

In the predetermined time P3 after the Vs1 voltage is supplied to the X electrode, in a mode 4, the switch Ys2 is turned on, and the switch Yg is turned off. Then, as shown in FIG. 4B, a current path □ is formed through the capacitors C3 and C4, the switch Xs1, the panel capacitor Cp, the switch Ys2, the capacitor C1, and the ground terminal 0. Through the current path □, the Vs2 voltage is supplied to the Y electrode of the panel capacitor Cp. In addition, when a discharge is generated between the X and Y electrode by the Vs1 voltage and 0V supplied in the mode 3, the discharge current flows through the current path □ to charge the capacitor C1.

In addition, 0V may be supplied to the X and Y electrodes when the switch Xs1 is turned off and the switches Yg and Xg are turned on between the mode 2 and mode 3, and in a like manner, 0V may be supplied to the X and Y electrodes when the switch Ys1 is turned off and the switches Yg and Xg are turned on after the mode 4.

Since the modes 1 to 4 are repeatedly performed, a sustain pulse can be supplied to the Y and X electrodes while respectively having the reverse phase. In addition, since the capacitors C1 and C3 are respectively charged by the discharge current on the modes 2 and 4, the voltage charged in the capacitors C1 and C3 can be used for supplying the Vs1 voltage on the modes 1 and 3. That is, since a power generated by the discharge current is reused through the capacitors C1 and C3 so as to supply the voltage for the sustain discharge, the power consumption is reduced.

According to the exemplary embodiment of the present invention, the discharge current and the power consumption are reduced since wall charges are formed on the scan and sustain electrodes in the sustain period. In addition, the power generated by the discharge current is reused for supplying the high level voltage of the sustain pulse, and therefore, the power consumption is further reduced. While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

What is claimed is:

1. A method of driving a plasma display having a plurality of first electrodes and a plurality of second electrodes, the plurality of first and second electrodes facilitating displaying an image, the method comprising:
supplying a first voltage to one of the plurality of first electrodes and supplying a second voltage lower than the first voltage to one of the plurality of second electrodes;
supplying a third voltage lower than the first voltage and higher than the second voltage to the one second electrode while the first voltage is being supplied to the one first electrode, after a first period of time from commencing supplying the first voltage to the one first electrode;
supplying the first voltage to the one second electrode and supplying the second voltage to the one first electrode; and
supplying the third voltage to the one first electrode after a second period of time from commencing supplying the first voltage to the one second electrode while the first voltage is being supplied to the one second electrode.

2. The driving method of claim 1, wherein a time for supplying the first voltage to the one first electrode comprises a time for supplying a third voltage to the one second electrode, and a time for supplying the first voltage to the one second electrode comprises a time for supplying the third voltage to the one first electrode.

3. The driving method of claim 1, wherein the second voltage comprises a ground voltage.

4. The driving method of claim 1, wherein one period among the first and second periods exceeds a discharge delay time between the one first electrode and the one second electrode.

5. A method of driving a plasma display having a plurality of first electrodes and a plurality of second electrodes, the plurality of first and second electrodes facilitating displaying an image, the driving method comprising:
maintaining a voltage at a positive first voltage for a first period, the voltage obtained by subtracting a voltage at one of the plurality of first electrodes from a voltage at one of the plurality of second electrodes;
maintaining the voltage for a second period at a positive second voltage lower than the first voltage;
maintaining a voltage for a third period at a third voltage higher than the second voltage; and then maintaining the voltage at a positive fourth voltage lower than the third voltage.

6. The driving method of claim 5, wherein the third voltage is equal to the first voltage, and the fourth voltage is equal to the second voltage.

7. The driving method of claim 5, wherein the first and third periods respectively comprise a discharge delay time between the one first and one second electrodes.

8. A plasma display, comprising:
a plurality of the first electrodes;
a plurality of the second electrodes adapted to facilitate displaying an image in cooperation with the plurality of first electrodes;
a first switch coupled between the plurality of first electrodes and a first power source and adapted to supply a first voltage;
a first capacitor having a first terminal coupled to the first power source and adapted to supply a second voltage;
a second switch coupled between the plurality of first electrodes and a second terminal of the first capacitor;
a second capacitor having a first terminal coupled to the second terminal of the first capacitor and adapted to supply a third voltage;
a third switch coupled between the plurality of first electrodes and a second terminal of the second capacitor;
a fourth switch coupled between the plurality of second electrodes and a second power source and adapted to supply a fourth voltage;
a third capacitor having a first terminal coupled to the second power source and adapted to supply a fifth voltage;
a fifth switch coupled between the plurality of second electrodes and a second terminal of the third capacitor;
a fourth capacitor having a first terminal coupled to the second terminal of the third capacitor and adapted to supply sixth voltage; and
a sixth switch coupled between the plurality of second electrodes and a second terminal of the fourth capacitor.

9. The plasma display of claim 8, wherein:
the third and fourth switches are adapted to be turned on for a first period;
the fourth switch is adapted to be turned off and the fifth switch is adapted to be turned on, for a second period after the first period;
the third and fifth switches are adapted to be turned off, and the first and sixth switches are adapted to be turned on, for a third period after the second period; and
the first switch is adapted to be turned off and the second switch is adapted to be turned on, for a fourth period after the third period.

10. The plasma display of claim 9, wherein:
the fifth switch is adapted to be turned off, and the first and fourth switches are adapted to be turned on, for a fifth period between the second period and the third period; and
the second switch is adapted to be turned off, and the first and fourth switches are adapted to be turned on, for a sixth period after the fourth period.

11. The plasma display of claim 9, wherein the first and second periods respectively comprise a discharge delay time between the first and second electrodes.

12. The plasma display of claim 8, wherein the first voltage is equal to the fourth voltage, and a sum of the second voltage and the third voltage is equal to a sum of the fifth voltage and the sixth voltage.

13. The plasma display of claim 12, wherein the first and fourth voltages comprise ground voltages.

14. The plasma display of claim 13, wherein the respective second terminals of the second capacitor and the fourth capacitor are coupled to a power source adapted to supply a voltage corresponding to a sum of the first, second, and third voltages.
